(19) United States
(12) Patent Application Publication
(10) Pub. No.: US 2005/0249923 A1
(43) Pub. Date: Nov. 10, 2005

(54) Digitally printed molding and trim

(76) Inventors: David P. Reichwein, Elizabethtown, PA (US); Timothy B. Burk, York, PA (US); Matthew S. Myers, Lititz, PA (US); Sunil Ramachandra, Lancaster, PA (US); James F. Mathis, Lancaster, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 11/092,482

(22) Filed: Mar. 29, 2005

Related U.S. Application Data
(60) Provisional application No. 60/568,426, filed on May 5, 2004.

(51) Int. Cl. C04B 41/00

(52) U.S. Cl. 428/195.1; 264/132; 264/138

(57) ABSTRACT

Molding and trim, which is placed at the intersection of the wall and floor or wall and ceiling, or as a transition between two floors, or as decorative pieces on a wall, has a digitally printed print layer. The printed pattern may be a wood grain pattern or other fanciful design. The pattern may be a looped pattern having no abrupt change in the printed pattern or a continuous pattern having no repeats. The molding or trim substrate may be a MDF laminate, a HDF laminate, solid wood or other material including plastic.

This invention is directed to molding and trim having a digitally printed print layer. The printed pattern may be a wood grain pattern or other fanciful design. The pattern may be a looped pattern having no abrupt change in the printed pattern or a continuous pattern having no repeats. The molding or trim substrate may be a MDF laminate, a HDF laminate or solid wood. The substrate can be other material, such as plastic, to make a vinyl cove base or molding.

### BACKGROUND OF THE INVENTION

Wood floors (solid, engineered wood and laminates) are gaining market share in the flooring sector. Along with the increased popularity of wood floor, the demand for wood molding and trim has increased. More and more wood patterns (i.e. wood species) and colors are being offered. As a result, more different patterns of molding and trim are being demanded, requiring smaller quantities of each wood pattern and color.

In the past melamine resin paper has been used to make the molding and trim. However, to justify printing a specific pattern a long print run has been required. Due to the limited life of the melamine resin paper, which becomes stiff and brittle as it ages, large quantities of unsold molding and trim have had to be destroyed.

Therefore, there is a need for a method to produce shorter runs of molding and trim, which will remain economically viable. Further, due to the increased cost and limited availability of some preferred wood species, lower cost methods of meeting the consumer demand are being sought.

Flexography is an offset technique where the printing plates or cylinders are made from rubber or photopolymers. The printing has been accomplished by the transfer of ink from the raised surface of the printing plate to the surface of the material being printed. The rotogravure method of printing uses a print cylinder with thousands of tiny cells which are below the surface of the printing cylinder. The ink is transferred from the cells when the print cylinder is brought into contact with the pressure sensitive label at the impression roll. Printing inks for flexography or rotogravure include solvent based inks, water based inks, and radiation cured inks.

While rotogravure and flexography printing does provide acceptable image quality, these two printing methods require expensive and time-consuming preparation of print cylinders or printing plates which make printing jobs of less than 100,000 units expensive as the setup cost and the cost of the cylinders or printing plates is typically depreciated over the size of the print job. These are the printing methods that have been used to produce the printed paper used to form the melamine resin laminates.

Recently, digital printing has become a viable method for the printing of information on packages. The term “digital printing” refers to the electronic digital characters or electronic digital images that can be printed by an electronic output device capable of translating digital information. The two main digital printing technologies are ink jet and electrophotography.

The introduction of piezo impulse drop-on-demand (DOD) and thermal DOD ink jet printers in the early 1980's provided ink jet printing systems. These early printers were very slow, and the ink jet nozzles often clogged. In the 1990's Hewlett Packard introduced the first monochrome ink jet printer, and shortly thereafter, the introduction of color, wide format ink jet printers enabled businesses to enter the graphic arts market. Today, a number of different ink jet technologies are being used for packaging, desktop, industrial, commercial, photographic, and textile applications.

In piezo technology, a piezo crystal is electrically excited to create pressure waves, which eject ink from the ink chamber. The ink can be electrically charged and deflected in a potential field, allowing the different characters to be created. More recent developments have introduced DOD multiple jets that utilize conductive piezo ceramic material which, when charged, increases the pressure in the channel and forces a drop of ink from the end of the nozzle. This allows for very small droplets of ink to form and be delivered at high speed at very high resolution, approximately 1,000 dpi printing.

Until recently, the use of color pigments in jet inks was uncommon. However, this is changing rapidly. Submicron pigments were developed in Japan for ink jet applications. Use of pigments allows for more temperature resistant inks required for thermal ink jet printers and laminations. Pigmented water-based jet inks and UV-curable jet inks are commercially available. Pigmented inks have greater lightfastness and water-resistance.

The concept of digital printing for decorative applications exists in prior art, however, the present invention relates to new techniques and applications. Among these are the use of evolving digital printing hardware for specific surface covering, particularly flooring, applications, including the production of molding and trim.

### SUMMARY OF THE INVENTION

On demand printing of films for wood accessories (e.g., molding and trim) eliminates traditional problems associated with melamine impregnated papers and attendant shelf life issues. Not only can a digitally printed film be adhered or laminated to a molding or trim substrate, the substrate can be directly digitally printed. Vinyl cove base or molding can be made by digitally printing on a plastic substrate.

The flexibility of digitally printing permits the manufacture of moldings and trims of indeterminate length. Even wood patterns can be developed that do not include abrupt changes in the pattern.

Further, the print runs can be relatively short when the pattern is digitally printed. Therefore, the necessity of large inventories is avoided.

### DETAILED DESCRIPTION OF THE INVENTION

Molding or trim, which is placed at the intersection of the wall and floor or wall and ceiling, or as a transition between two floors, or as decorative pieces on a wall, is typically made using a melamine impregnated paper. This paper has a limited shelf-life, causing very substantial quantities to be destroyed when the paper hardens and cracks. Also, because large quantities of the paper must be printed at one time and there are numerous print designs and colors, the problem is exacerbated.

Digital printing of the molding or trim designs or patterns overcomes the problem of the using the melamine impregnated paper. Further, shorter on demand runs of the various patterns can be printed.

The molding or trim substrate may be any typical substrate material including Medium Density Fiberboard (MDF), High Density Fiberboard (HDF) and solid wood. For the purposes of the present invention, the term “molding” is intended to include vinyl cove base or molding.

Still further, the use of digital printing allows the molding to be made with any length without having seams of abrupt changes in pattern. In fact, the molding pattern can be printed in an endless loop or a pattern of infinite non-repeating length.

Since the application of the digital print ink can be controlled by a computer, the digital pattern can be repeated in a looped pattern or be non-repeating. The non-repeating pattern is obtained by using a computer algorithm. By using an algorithm to generate the pattern as it is being applied, the repeat length can be infinite.

If the pattern loops or repeats, it is desirable to have the pattern on each side of the pattern splice merge so that there is no abrupt, noticeable change or break in the pattern. Depending on how much computer memory is used, the length of the loop can be varied and easily exceed 60 or 96 inches, which is the typical maximum length of the molding and trim presently in the market.

The pattern can also be varied by developing a number of pattern segments with similar designs at the beginning and end points. Then the segments can be randomly selected to vary the pattern without an abrupt or noticeable change or break in the pattern.

The pattern can also be varied by moving the print head while it is applying the ink. This results in a dynamic pattern. If the print head is moved in a random manner, the computer is programmed to randomly select loop segments or the print images are randomly selected, a random pattern results.

In another embodiment, the digitally printed layer can be in the form of a free-standing film or paper, which film or paper can be laminated to a substrate to form a molding or trim. The free-standing film can optionally include a pad coat. The free-standing film can include a transparent or translucent film with the print layer being interposed between the transparent or translucent film and the pad coat. When laminated to a substrate, the transparent or translucent film can act as a wear layer.

Digital printing ink is characterized by a viscosity and particle size that permits application with an ink jet. The digital printing ink can be water-based, solvent-based or 100% solids. The 100% solids inks are typically UV cured.

The molding can be formed by printing the digital printing on the substrate which has previously been printed with a rotogravure printing ink, transfer printing ink, flexographic printing ink or other analog printing technique. In this embodiment, the first printed ink will be interposed between the substrate and the digital printing ink.

A molding or trim can be made by forming a base, applying an opaque pad coat to the base, and digitally printing a print layer onto the pad coat. The pad coat may be applied with any known method including a reverse roll coater or by digitally printing the pad coat.

1. A molding comprising a molding substrate and a digitally printed layer.

2. The molding of claim 1, wherein the molding substrate is selected from the group consisting of MDF laminate, HDF laminate, solid wood and plastic.

3. The molding of claim 1, wherein the printed layer comprises a looped pattern.

4. The molding of claim 3, wherein the looped pattern is continuous having no abrupt change in the printed pattern.

5. The molding of claim 4, wherein the looped pattern is formed by combining a plurality of pattern segments having different designs.

6. The molding of claim 5, wherein the plurality pattern segments are randomly selected.

7. The molding of claim 1, wherein the printed layer has a repeat length of at least 60 inches.

8. The molding of claim 1, wherein the printed layer has a no repeat length.

9. The molding of claim 1, wherein the printed layer is printed on a print substrate selected from the group consisting of a film, paper and the combination of a film and paper, the print substrate being adhered to the molding substrate.

10. The molding of claim 9, wherein the printed layer is interposed between the film and the molding substrate.

11. The molding of claim 1, wherein the printed layer is printed directly on the substrate.

12. The molding of claim 1, wherein the printed layer further comprises a second ink selected from the group consisting of rotogravure printing ink, transfer printing ink and flexographic printing ink, the second ink being interposed between the substrate and the digital printing ink.

13. A method of making a molding or trim comprising digitally printing a looped pattern having no abrupt pattern change, adhering the looped pattern to a molding or trim substrate, and cutting the molding or trim substrate to any desired length, whereby none of the cut molding or trim has a discontinuous printed pattern with an abrupt change in the printed pattern.

14. The method of claim 13, wherein the printed pattern is adhered directly to the substrate.

15. The method of claim 13, wherein the printed pattern is printed onto a print substrate selected from the group consisting of a film, paper and the combination of a film and paper and the print substrate is adhered to the substrate.

16. The method of claim 13, wherein the printed pattern is a wood grain pattern.

17. The method of claim 13, wherein the looped pattern is formed by combining a plurality pattern segments having different designs.

18. The method of claim 17, wherein the plurality of pattern segments are randomly selected.
